(19) United States
(12) Patent Application Publication
(10) Pub. No.: US 2018/0367287 A1
(43) Pub. Date: Dec. 20, 2018

(54) Sounding Reference Signal And Channel State Information-Reference Signal Co-Design In Mobile Communications

(71) Applicant: MediaTek Inc., Hsinchu City (TW)

(72) Inventors: Bo-Si Chen, Hsinchu City (TW); Weidong Yang, San Diego, CA (US)

(21) Appl. No.: 16/009,539

(22) Filed: Jun. 15, 2018

Related U.S. Application Data
(60) Provisional application No. 62/521,301, filed on Jun. 16, 2017.

(51) Int. Cl. H04L 5/00; H04L 1/00; H04L 25/02; H04J 13/00

(52) U.S. Cl. CPC H04L 5/0073; H04L 1/0026; H04J 13/0062; H04L 25/0224; H04L 5/0048

(57) ABSTRACT

Various solutions for sounding reference signal (SRS) and channel state information-reference signal (CSI-RS) co-design with respect to user equipment and network apparatus in mobile communications are described. An apparatus may receive a first sequence in a time-frequency resource. The apparatus may receive a second sequence in the same time-frequency resource. The apparatus may determine a first reference signal according to the first sequence. The apparatus may determine a second reference signal according to the second sequence. The apparatus may perform interference measurement based on the first reference signal and the second reference signal.

### CROSS REFERENCE TO RELATED PATENT APPLICATION(S)

The present disclosure is part of a non-provisional application claiming the priority benefit of U.S. Patent Application No. 62/521,301, filed on 16 Jun. 2017, the content of which is incorporated by reference in its entirety.

### TECHNICAL FIELD

The present disclosure is generally related to mobile communications and, more particularly, to sounding reference signal (SRS) and channel state information-reference signal (CSI-RS) co-design with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE), New Radio (NR) or a newly developed wireless communication system, cross link interference (CLI) may occur among a plurality of nodes. Each node in the wireless network may be a network apparatus (e.g., a transmit/receive point (TRP)) or a communication apparatus (e.g., a user equipment (UE)). A UE may be engaged in communication with a TRP, another UE, or both, at a given time. Thus, the cross link interference measurements may associate three types of node pairs: TRP-TRP, TRP-UE and UE-UE.

In order to avoid or mitigate the CLI, CLI measurements may be needed. For example, UE-UE, TRP-TRP or TRP-UE interference measurements may become important and necessary. For performing the CLI measurement, some reference signals may be needed for measurements by a node. For example, a channel state information-reference signal (CSI-RS) may be used for TRP-TRP interference measurements. A sounding reference signal (SRS) may be used for UE-UE interference measurements.

Accordingly, how to transmit/receive the reference signals (e.g., SRS and CSI-RS) and perform CLI measurements may become important for interference management. In order to facilitate CLI measurements, it is needed to provide proper design for the reference signals.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to SRS and CSI-RS co-design with respect to user equipment and network apparatus in mobile communications.

In one aspect, a method may involve an apparatus receiving a first sequence in a time-frequency resource. The method may also involve the apparatus receiving a second sequence in the same time-frequency resource. The method may further involve the apparatus determining a first reference signal according to the first sequence. The method may further involve the apparatus determining a second reference signal according to the second sequence. The method may further involve the apparatus performing interference measurement based on the first reference signal and the second reference signal.

In one aspect, an apparatus may comprise a transceiver capable of wirelessly communicating with a plurality of nodes of a wireless network. The apparatus may also comprise a processor communicatively coupled to the transceiver. The processor may be capable of receiving a first sequence in a time-frequency resource. The processor may also be capable of receiving a second sequence in the same time-frequency resource. The processor may further be capable of determining a first reference signal according to the first sequence. The processor may further be capable of determining a second reference signal according to the second sequence. The processor may further be capable of performing interference measurement based on the first reference signal and the second reference signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to SRS and CSR-RS co-design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE, NR or a newly developed wireless communication system, CLI may occur among a plurality of nodes. Each node in the wireless network may be a network apparatus (e.g., TRP) or a communication apparatus (e.g., UE). A UE may be engaged in communication with a TRP, another UE, or both, at a given time. Thus, the cross link interference measurements may associate three types of node pairs: TRP-TRP, TRP-UE and UE-UE. Herein, a TRP may be an eNB in an LTE-based network or a gNB in a 5G/NR network.

In order to management or mitigate the CLI, CLI measurements may be needed. For example, UE-UE, TRP-TRP or TRP-UE interference measurements may become important and necessary. For performing the CLI measurement, some reference signals may be needed for measurements by a node. For example, a CSI-RS may be used for TRP-TRP interference measurements and an SRS may be used for UE-UE interference measurements. The signal used for the CLI measurement may be classified as the CLI reference signal (RS). In other words, the CLI RS may comprise the CSI-RS or the SRS. In some implementations, the CSI-RS may also be used for TRP-UE or UE-UE interference measurements. The SRS may also be used for TRP-UE or TRP-TRP interference measurements.

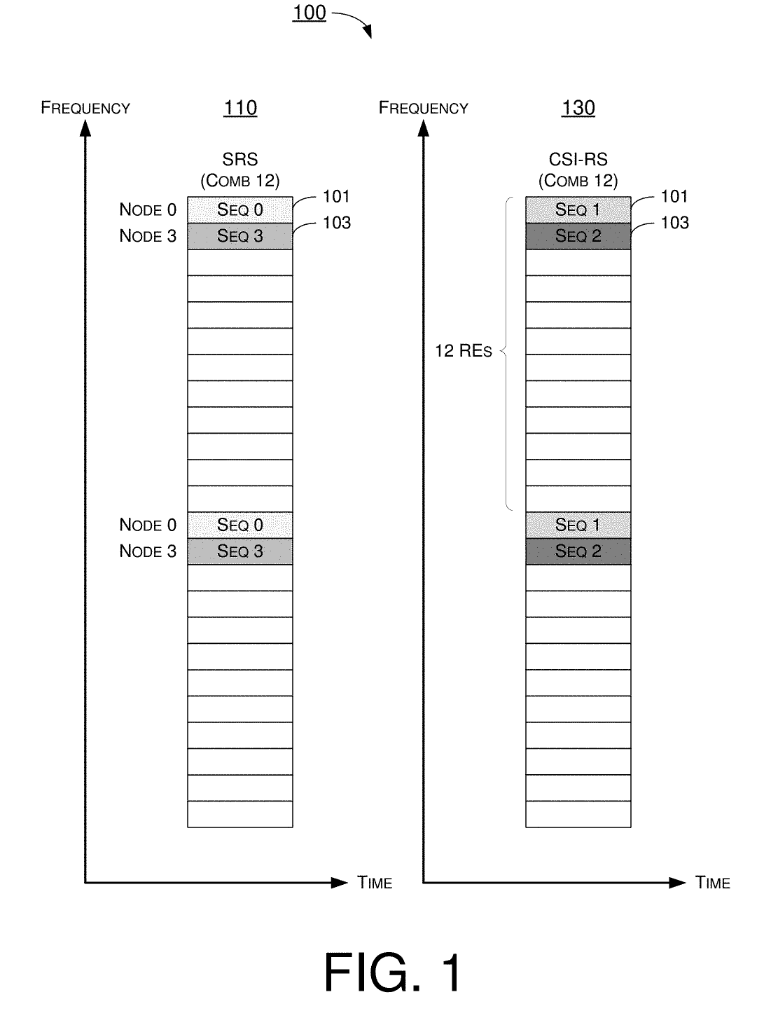

FIG. 1 illustrates an example scenario 100 under schemes in accordance with implementations of the present disclosure. Scenario 100 involves a UE and a plurality of nodes, which may be a part of a wireless communication network (e.g., an LTE network, an LTE-Advanced network, an LTE-Advanced Pro network, a 5G network, an NR network, an IoT network or an NB-IoT network). To support CLI measurements and keep the symmetry of downlink and uplink slot structure, it may have benefits to make the SRS and the CSI-RS share the same time-frequency resources and have the similar pattern and sequence design. The UE may be configured to receive a first reference signal (e.g., SRS) and a second reference signal (e.g., CSI-RS) at the same time and in the same time-frequency resource.

FIG. 1 illustrates an example SRS design 110 and an example CSI-RS design 130. SRS design 110 may comprise a first sequence (e.g., Seq 0). The first sequence may comprise a Zadoff-Chu (ZC)-based sequence. The first sequence may be allocated at time-frequency resource 101. Time-frequency resource 101 may comprise a resource allocation unit such as a resource element (RE) of a physical resource block (PRB). The first sequence may be transmitted by a first node (e.g., Node 0). SRS design 110 may be configured with a comb number 12. Specifically, the sequence of the SRS may be periodically transmitted by a node. The sequence may be repeatedly distributed over a plurality of radio resources. For example, as showed in FIG. 1, the comb number 12 represents that the sequences may be allocated in every 12 REs in frequency domain. The density of SRS design 110 may be determined as D=1 RE/port/PRB since the SRS is allocated in 1 RE per PRB for 1 antenna port.

CSI-RS design 130 may comprise a second sequence (e.g., Seq 1). The second sequence may comprise a ZC-based sequence which comprises an identical sequence structure with the first sequence (e.g., Seq 0). The sequence structure of the first sequence (e.g., Seq 0) and the second sequence (e.g., Seq 1) may be the same, but the sequence parameters such as the root sequence or the shift of the sequence may be different. The second sequence may be allocated at the same time-frequency resource 101. The second sequence may be transmitted by another node (e.g., TRP). CSI-RS design 130 may be configured with a comb number 12. Similarly, the sequence of the CSI-RS may be periodically transmitted by a node. The sequence may be repeatedly distributed over a plurality of radio resources. For example, as showed in FIG. 1, the comb number 12 represents that the sequences may be allocated in every 12 REs in frequency domain.

CSI-RS design 130 may further comprise a third sequence (e.g., Seq 2) which may comprise the same ZC-based sequence as the first sequence (e.g., Seq 0) and the second sequence (e.g., Seq 1). The third sequence may be allocated at time-frequency resource 103. The second sequence and the third sequence may be transmitted by different nodes or the same node with different antenna ports. For example, CSI-RS design 130 may be an example of 2-port CSI-RS with density D=1 RE/port/PRB since the CSI-RS is allocated in 2 REs per PRB for 2 antenna ports. The density of the CSI-RS may be identical to the density of the SRS.

The CSI-RS may further comprise a mask such as an orthogonal cover code (OCC). The OCC may be applied on the CSI-RS from different transmitting sources (e.g., different antenna ports or different nodes). For example, the second sequence (e.g., Seq 1) and the third sequence (e.g., Seq 2) transmitted by a first antenna port may comprise an OCC of (+1, +1). The second sequence (e.g., Seq 1) and the third sequence (e.g., Seq 2) transmitted by a second antenna port may comprise an OCC of (+1, −1). The receiving node may be able to determine or differentiate the sources of the second sequence and the third sequence according to the OCC. For example, the receiving node may be able to differentiate the CSI-RS from different antenna ports by the OCC. In some implementations, the OCC may also be applied on the SRS.

SRS design 110 may further comprise a fourth sequence (e.g., Seq 3) which may comprise the same ZC-based sequence as the first sequence (e.g., Seq 0). The fourth sequence may be allocated at time-frequency resource 103. The first sequence and the fourth sequence may be transmitted by different nodes. For example, the first sequence may be transmitted by a first node (e.g., Node 0) and the fourth sequence may be transmitted by a second node (e.g., Node 3). Accordingly, in scenario 100, SRS design 110 may be configured with the same comb number to match the RE pattern of CSI-RS design 130. CSI-RS design 130 may be configured with the same ZC-based sequence as SRS design 110. Thus, SRS design 110 and CSI-RS design 130 may comprise the same pattern and sequence design and may share the same time-frequency resources.

The UE may be configured to receive the first sequence (e.g., Seq 0) and the second sequence (e.g., Seq 1) in the same time-frequency resource (e.g., time-frequency resource 101). In a case that good cross-correlation property is held between the SRS and the CSI-RS, the UE may be able to separate the SRS from the CSI-RS. The UE may be configured to determine a first reference signal (e.g., SRS) according to the first sequence and determine a second reference signal (e.g., CSI-RS) according to the second sequence. The UE may be configured to perform interference measurement (e.g., CLI measurement) based on the first reference signal and the second reference signal. Since the SRS and the CSI-RS have the same sequence structure and are transmitted in the same time-frequency resource, the UE may be able to decode the SRS and the CSI-RS and perform the CLI measurement. The SRS may be transmitted by a UE. The CSI-RS may be transmitted by a TRP. The UE may not need to know the sources of the SRS and the CSI-RS (e.g., a UE or a TRP). The UE may solely determine whether any interference is presented. Accordingly, it may be more flexible and more efficient for the UE to perform CLI measurement. The UE may use the same decoding method to process the reference signals (e.g., SRS or CSI-RS) transmitted from other UEs or TRPs.

In some implementation, the network node may indicate the locations or the possible locations (e.g., time-frequency regions) of the reference signals (e.g. SRS or CSI-RS) to the UE. The reference signals may be allocated in some specific locations or may be randomly allocated in any locations. The UE may be able to receive and decode the reference signals according to the location indication received from the network node.

In some implementation, the UE may further be configured to report the measurement result to a node (e.g., serving TRP) after performing the CLI measurement. The UE may also be configured to determine whether to transmit the uplink data according to the result of the CLI measurement. In a case that the measurement result indicates that the interference is presented, the UE may determine not to transmit the uplink data.

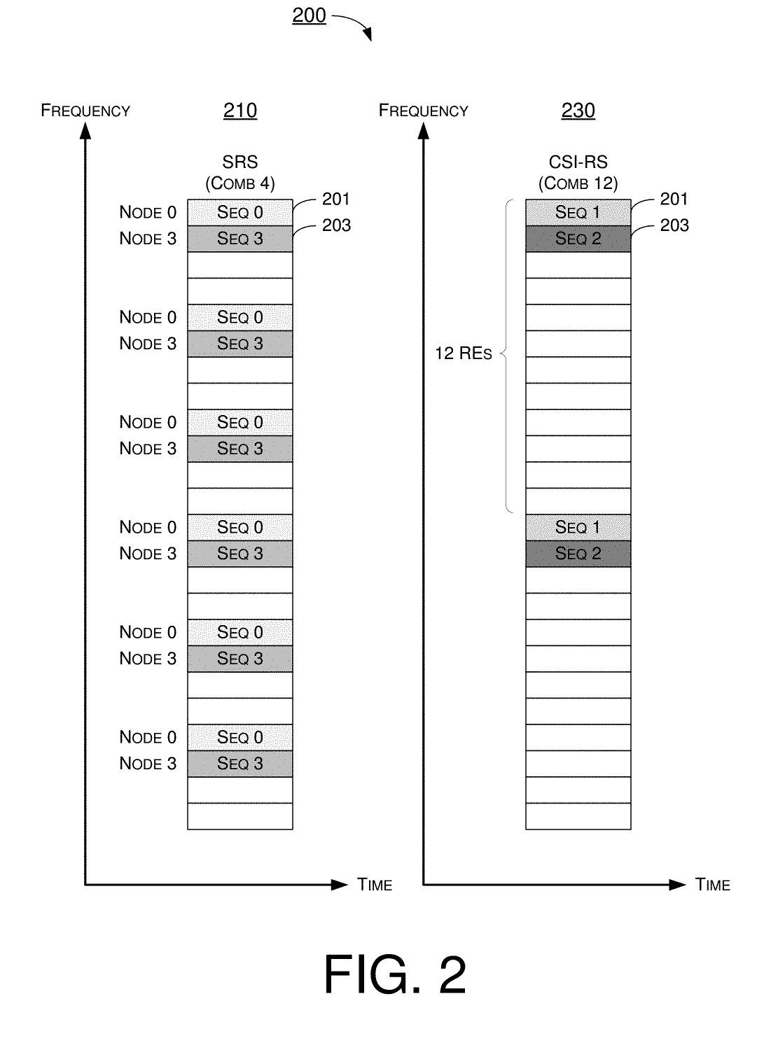

FIG. 2 illustrates an example scenario 200 under schemes in accordance with implementations of the present disclosure. Scenario 200 involves a UE and a plurality of nodes, which may be a part of a wireless communication network (e.g., an LTE network, an LTE-Advanced network, an LTE-Advanced Pro network, a 5G network, an NR network, an IoT network or an NB-IoT network). FIG. 2 illustrates an alternative implementation for the SRS and the CSI-RS co-design. The CSI-RS may be configured with the same ZC-based sequence as the SRS. The CSI-RS may be configured with down sampled sequences. In other words, the density of the SRS may be greater than the density of the CSI-RS.

FIG. 2 illustrates an example SRS design 210 and an example CSI-RS design 230. SRS design 210 may comprise a first sequence (e.g., Seq 0). The first sequence may comprise a ZC-based sequence. The first sequence may be allocated at time-frequency resource 201. Time-frequency resource 201 may comprise a RE. The first sequence may be transmitted by a first node (e.g., Node 0). SRS design 210 may be configured with a comb number 4. As showed in FIG. 2, the comb number 4 represents that the sequences may be allocated in every 4 REs in frequency domain. The density of SRS design 210 may be determined as D=3 RE/port/PRB since the SRS is allocated in 3 RE per PRB for 1 antenna port.

CSI-RS design 230 may comprise a second sequence (e.g., Seq 1). The second sequence may comprise a ZC-based sequence which comprises an identical sequence structure with the first sequence (e.g., Seq 0). The sequence structure of the first sequence (e.g., Seq 0) and the second sequence (e.g., Seq 1) may be the same, but the sequence parameters such as the root sequence or the shift of the sequence may be different. The second sequence may be allocated at the same time-frequency resource 201. The second sequence may be transmitted by another node (e.g., TRP). CSI-RS design 230 may be configured with a comb number 12. As showed in FIG. 2, the comb number 12 represents that the sequences may be allocated in every 12 REs in frequency domain.

CSI-RS design 230 may further comprise a third sequence (e.g., Seq 2) which may comprise the same ZC-based sequence as the first sequence (e.g., Seq 0) and the second sequence (e.g., Seq 1). The third sequence may be allocated at time-frequency resource 203. The second sequence and the third sequence may be transmitted by different nodes or the same node with different antenna ports. For example, CSI-RS design 230 may be an example of 2-port CSI-RS with density D=1 RE/port/PRB since the CSI-RS is allocated in 2 REs per PRB for 2 antenna ports. In this implementation, the density of the CSI-RS is different from the density of the SRS. The patterns of the SRS and the CSI-RS are not matched. The sequences of the CSI-RS comprise the down sampled ZC-based sequences compared to the sequences of the SRS.

Similarly, the CSI-RS may further comprise a mask such as an OCC. The OCC may be applied on the CSI-RS from different transmitting sources (e.g., different antenna ports or different nodes). For example, the second sequence (e.g., Seq 1) and the third sequence (e.g., Seq 2) transmitted by a first antenna port may comprise an OCC of (+1, +1). The second sequence (e.g., Seq 1) and the third sequence (e.g., Seq 2) transmitted by a second antenna port may comprise an OCC of (+1, −1). The receiving node may be able to determine or differentiate the sources of the second sequence and the third sequence according to the OCC. For example, the receiving node may be able to differentiate the CSI-RS from different antenna ports by the OCC. In some implementations, the OCC may also be applied on the SRS.

SRS design 210 may further comprise a fourth sequence (e.g., Seq 3) which may comprise the same ZC-based sequence as the first sequence (e.g., Seq 0). The fourth sequence may be allocated at time-frequency resource 203. The first sequence and the fourth sequence may be transmitted by different nodes. For example, the first sequence may be transmitted by a first node (e.g., Node 0) and the fourth sequence may be transmitted by a second node (e.g., Node 3). Accordingly, in scenario 200, SRS design 210 may be configured with a comb number (e.g., comb 4) less than a comb number of CSI-RS design 230 (e.g., comb 12). CSI-RS design 230 may be configured with the same ZC-based sequence as SRS design 210. CSI-RS design 230 may comprise down sampled sequences compared to SRS design 210. Thus, SRS design 110 and CSI-RS design 130 may have the same sequence design with different densities. Such design may be preferable for both the SRS and the CSI-RS since high density SRS may have better system performance and low density CSI-RS may reduce signaling overhead.

Since the RE pattern of the CSI-RS may be different from the SRS, the transmitting node may indicate the location of the time-frequency resource for the CSI-RS to the UE. The UE may be configured to receive and determine the CSI-RS according to the location of the time-frequency resource.

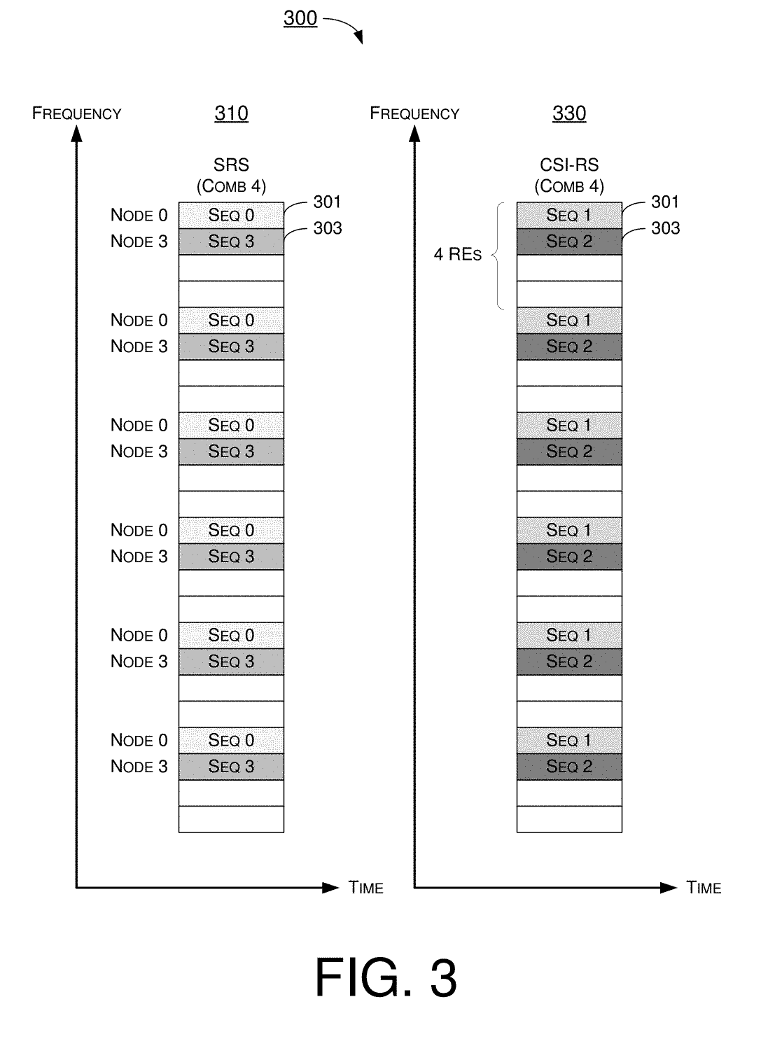

FIG. 3 illustrates an example scenario 300 under schemes in accordance with implementations of the present disclosure. Scenario 300 involves a UE and a plurality of nodes, which may be a part of a wireless communication network (e.g., an LTE network, an LTE-Advanced network, an LTE-Advanced Pro network, a 5G network, an NR network, an IoT network or an NB-IoT network). FIG. 3 illustrates an alternative implementation for the SRS and the CSI-RS co-design. The CSI-RS may be configured with the same ZC-based sequence as the SRS. The CSI-RS may be configured the same density with the SRS to match the SRS RE pattern.

FIG. 3 illustrates an example SRS design 310 and an example CSI-RS design 330. SRS design 310 may comprise a first sequence (e.g., Seq 0). The first sequence may comprise a ZC-based sequence. The first sequence may be allocated at time-frequency resource 301. Time-frequency resource 301 may comprise a RE. The first sequence may be transmitted by a first node (e.g., Node 0). SRS design 310 may be configured with a comb number 4. As showed in FIG. 3, the comb number 4 represents that the sequences may be allocated in every 4 REs in frequency domain. The density of SRS design 310 may be determined as D=3 RE/port/PRB since the SRS is allocated in 3 RE per PRB for 1 antenna port.

CSI-RS design 330 may comprise a second sequence (e.g., Seq 1). The second sequence may comprise a ZC-based sequence which comprises an identical sequence structure with the first sequence (e.g., Seq 0). The sequence structure of the first sequence (e.g., Seq 0) and the second sequence (e.g., Seq 1) may be the same, but the sequence parameters such as the root sequence or the shift of the sequence may be different. The second sequence may be allocated at the same time-frequency resource 301. The second sequence may be transmitted by another node (e.g., TRP). CSI-RS design 330 may be configured with a comb number 4. As showed in FIG. 3, the comb number 4 represents that the sequences may be allocated in every 4 REs in frequency domain.

CSI-RS design 330 may further comprise a third sequence (e.g., Seq 2) which may comprise the same ZC-based sequence as the first sequence (e.g., Seq 0) and the second sequence (e.g., Seq 1). The third sequence may be allocated at time-frequency resource 303. The second sequence and the third sequence may be transmitted by different nodes or the same node with different antenna ports. For example, CSI-RS design 330 may be an example of 2-port CSI-RS with density D=3 RE/port/PRB since the CSI-RS is allocated in 6 REs per PRB for 2 antenna ports. In this implementation, the density of the CSI-RS is identical to the density of the SRS with a higher density (e.g., comb 4). The patterns of the SRS and the CSI-RS are matched.

Similarly, the CSI-RS may further comprise a mask such as an OCC. The OCC may be applied on the CSI-RS from different transmitting sources (e.g., different antenna ports or different nodes). For example, the second sequence (e.g., Seq 1) and the third sequence (e.g., Seq 2) transmitted by a first antenna port may comprise an OCC of (+1, +1). The second sequence (e.g., Seq 1) and the third sequence (e.g., Seq 2) transmitted by a second antenna port may comprise an OCC of (+1, −1). The receiving node may be able to determine or differentiate the sources of the second sequence and the third sequence according to the OCC. For example, the receiving node may be able to differentiate the CSI-RS from different antenna ports by the OCC. In some implementations, the OCC may also be applied on the SRS.

SRS design 310 may further comprise a fourth sequence (e.g., Seq 3) which may comprise the same ZC-based sequence as the first sequence (e.g., Seq 0). The fourth sequence may be allocated at time-frequency resource 303. The first sequence and the fourth sequence may be transmitted by different nodes. For example, the first sequence may be transmitted by a first node (e.g., Node 0) and the fourth sequence may be transmitted by a second node (e.g., Node 3). Accordingly, in scenario 300, CSI-RS design 330 may be configured with the same comb number (e.g., comb 4) to match the RE pattern of SRS design 310. CSI-RS design 330 may be configured with the same ZC-based sequence as SRS design 310. Thus, SRS design 310 and CSI-RS design 330 may comprise the same pattern and sequence design and may share the same time-frequency resources.

### Illustrative Implementations

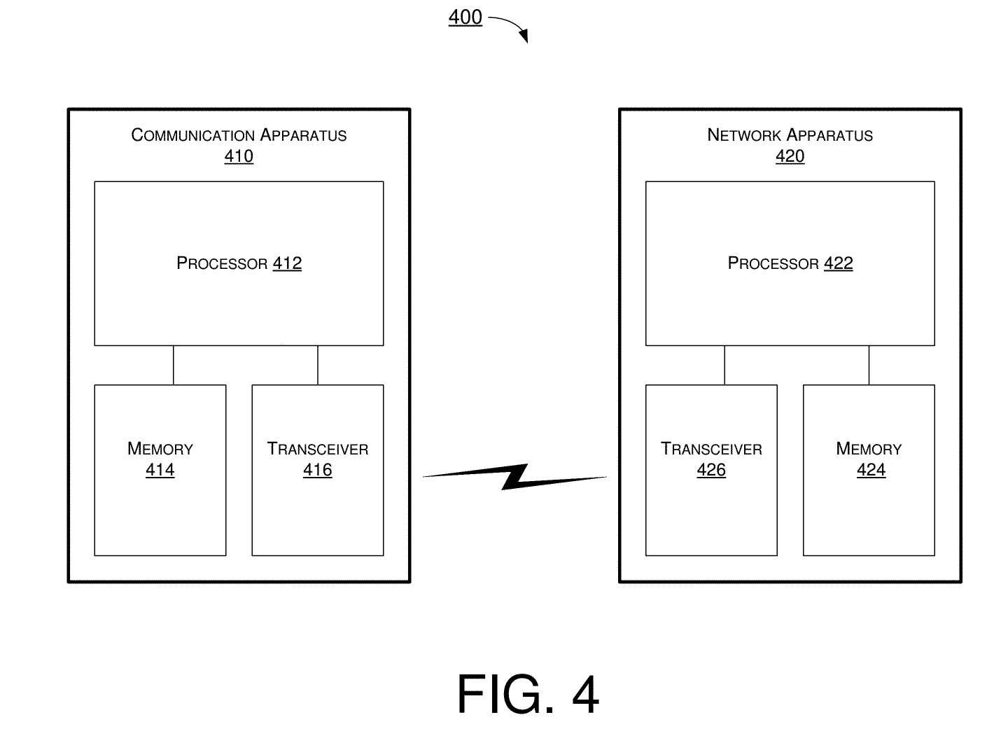

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to SRS and CSI-RS co-design with respect to user equipment and network apparatus in wireless communications, including scenarios 100, 200 and 300 described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT or NB-IoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, or one or more complex-instruction-set-computing (CISC) processors. Communication apparatus 410 may include at least some of those components shown in FIG. 4 such as a processor 412, for example. communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a TRP, a base station, a small cell, a router or a gateway. For instance, network apparatus 420 may be implemented in an eNodeB in an LTE, LTE-Advanced or LTE-Advanced Pro network or in a gNB in a 5G, NR, IoT or NB-IoT network. Alternatively, network apparatus 420 may be implemented in the form of one or more IC chips such as, for example and without limitation, one or more single-core processors, one or more multi-core processors, or one or more CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may be configured to receive, via transceiver 416, a first sequence and a second sequence in the same time-frequency resource. In a case that good cross-correlation property is held between the SRS and the CSI-RS, processor 412 may be able to separate the SRS from the CSI-RS. Processor 412 may be configured to determine a first reference signal (e.g., SRS) according to the first sequence and determine a second reference signal (e.g., CSI-RS) according to the second sequence. Processor 412 may be configured to perform interference measurement (e.g., CLI measurement) based on the first reference signal and the second reference signal. Since the SRS and the CSI-RS have the same sequence structure and are transmitted in the same time-frequency resource, processor 412 may be able to decode the SRS and the CSI-RS and perform the CLI measurement. The SRS may be transmitted by a communication apparatus. The CSI-RS may be transmitted by a network apparatus. Processor 412 may not need to know the sources of the SRS and the CSI-RS. Processor 412 may solely determine whether any interference is presented. Processor 412 may use the same decoding method to process the reference signals (e.g., SRS or CSI-RS) transmitted from other nodes.

In some implementation, the first sequence and the second sequence may comprise an identical sequence structure. For example, the first sequence may comprise a ZC-based sequence. The second sequence may also comprise a ZC-based sequence identical to the first sequence. The sequence structure of the first sequence and the second sequence may be the same, but the sequence parameters such as the root sequence or the shift of the sequence may be different. The first sequence and the second sequence may be allocated at the same time-frequency resource. The time-frequency resource may comprise a resource allocation unit such as a RE of a PRB. The first sequence and the second sequence may be transmitted by the same node or by different nodes. The first reference signal and the second reference signal may be configured with the same comb number. The density of the first reference signal may be identical to the density of the second reference signal.

In some implementation, the first reference signal and the second reference signal may be configured with different comb numbers. For example, the comb number of the first reference signal may be less than the comb number of the second reference signal. The density of the first reference signal may be different from the density of the second reference signal. For example, the density of the first reference signal may be greater than the density of the second reference signal. The patterns of the first reference signal and the second reference signal may not be matched. The sequences of the second reference signal comprise the down sampled ZC-based sequences compared to the sequences of the first reference signal.

In some implementation, the second reference signal may further comprise a mask such as an OCC. Processor 412 may be able to determine or differentiate the second reference signal according to the OCC. For example, processor 412 may be able to differentiate the CSI-RS from different antenna ports by the OCC. In some implementations, the OCC may also be applied on the SRS. Processor 412 may be able to determine or differentiate the first reference signal according to the OCC.

In some implementation, network apparatus 420 may indicate the locations or the possible locations (e.g., time-frequency regions) of the reference signals (e.g. SRS or CSI-RS) to communication apparatus 410. The reference signals may be allocated in some specific locations or may be randomly allocated in any locations. Processor 412 may be able to receive and decode the reference signals according to the location indication received from the network node.

In some implementation, processor 412 may further be configured to report the measurement result to network apparatus 420 after performing the CLI measurement. Processor 412 may also be configured to determine whether to transmit the uplink data according to the result of the CLI measurement. In a case that the measurement result indicates that the interference is presented, processor 412 may determine not to transmit the uplink data.

In some implementation, the RE pattern of the CSI-RS may be different from the SRS, the transmitting node (e.g., network apparatus 420) may indicate the location of the time-frequency resource for the CSI-RS to communication apparatus 410. Processor 412 may be configured to receive and determine the CSI-RS according to the location of the time-frequency resource.

### Illustrative Processes

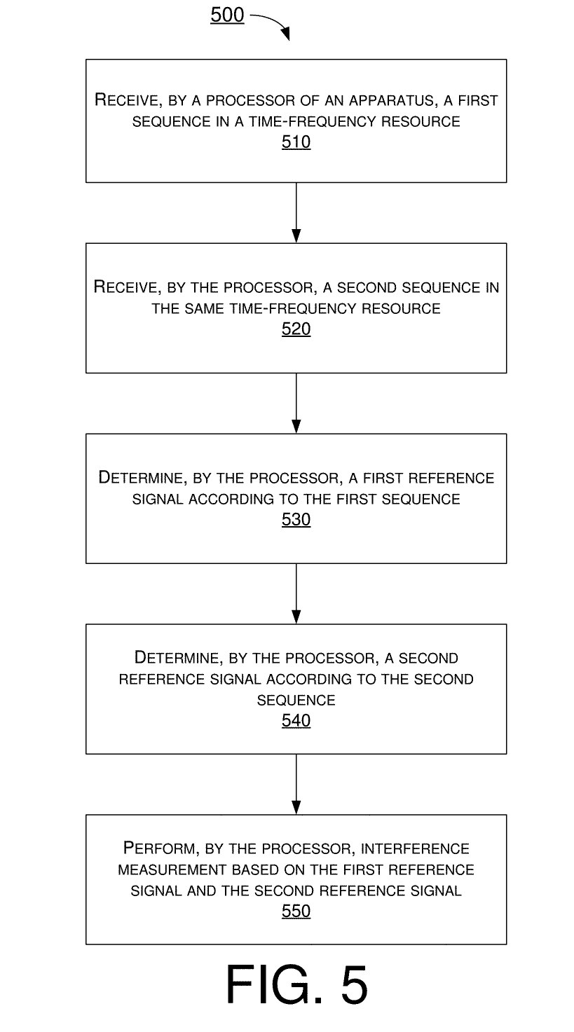

FIG. 5 illustrates an example process 500 in accordance with an implementation of the present disclosure. Process 500 may be an example implementation of scenarios 100, 200 and 300, whether partially or completely, with respect to SRS and CSI-RS co-design in accordance with the present disclosure. Process 500 may represent an aspect of implementation of features of communication apparatus 410. Process 500 may include one or more operations, actions, or functions as illustrated by one or more of blocks 510, 520, 530, 540 and 550. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 receiving a first sequence in a time-frequency resource. Process 500 may proceed from 510 to 520.

At 520, process 500 may involve processor 412 receiving a second sequence in the same time-frequency resource. Process 500 may proceed from 520 to 530.

At 530, process 500 may involve processor 412 determining a first reference signal according to the first sequence. Process 500 may proceed from 530 to 540.

At 540, process 500 may involve processor 412 determining a second reference signal according to the second sequence. Process 500 may proceed from 540 to 550.

At 550, process 500 may involve processor 412 performing interference measurement based on the first reference signal and the second reference signal.

In some implementations, the first reference signal may comprise an SRS. The second reference signal may comprise a CSI-RS.

In some implementations, the first sequence and the second sequence may comprise an identical sequence structure. The first sequence and the second sequence may comprise a ZC-based sequence.

In some implementations, the second sequence may comprise a down sampled ZC-based sequence compared to the first sequence.

In some implementations, a first comb number of the first reference signal may be identical to a second comb number of the second reference signal. A first density of the first reference signal may be identical to a second density of the second reference signal.

In some implementations, a first density of the first reference signal may be greater than a second density of the second reference signal.

In some implementations, the second reference signal may further comprise an OCC. Process 500 may involve communication apparatus 410 differentiating the second reference signal according to the OCC.

In some implementations, process 500 may involve processor 412 determining the second reference signal according to a location of the time-frequency resource.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first sequence in a time-frequency resource;
receiving, by the processor, a second sequence in the same time-frequency resource;
determining, by the processor, a first reference signal according to the first sequence;
determining, by the processor, a second reference signal according to the second sequence; and
performing, by the processor, interference measurement based on the first reference signal and the second reference signal.

2. The method of claim 1, wherein the first reference signal comprises a sounding reference signal (SRS), and wherein the second reference signal comprises a channel state information-reference signal (CSI-RS).

3. The method of claim 1, wherein the first sequence and the second sequence comprise an identical sequence structure.

4. The method of claim 1, wherein the first sequence and the second sequence comprise a Zadoff-Chu (ZC)-based sequence.

5. The method of claim 1, wherein the second sequence comprises a down sampled Zadoff-Chu (ZC)-based sequence compared to the first sequence.

6. The method of claim 1, wherein a first comb number of the first reference signal is identical to a second comb number of the second reference signal.

7. The method of claim 1, wherein a first density of the first reference signal is identical to a second density of the second reference signal.

8. The method of claim 1, wherein a first density of the first reference signal is greater than a second density of the second reference signal.

9. The method of claim 1, further comprising:
differentiating, by the processor, the second reference signal according to an orthogonal cover code (OCC),
wherein the second reference signal further comprises the OCC.

10. The method of claim 1, further comprising:
determining, by the processor, the second reference signal according to a location of the time-frequency resource.

11. An apparatus, comprising:
a transceiver capable of wirelessly communicating with a plurality of nodes of a wireless network; and
a processor communicatively coupled to the transceiver, the processor capable of:
receiving, via the transceiver, a first sequence in a time-frequency resource;
receiving, via the transceiver, a second sequence in the same time-frequency resource;
determining a first reference signal according to the first sequence;
determining a second reference signal according to the second sequence; and
performing interference measurement based on the first reference signal and the second reference signal.

12. The apparatus of claim 11, wherein the first reference signal comprises a sounding reference signal (SRS), and wherein the second reference signal comprises a channel state information-reference signal (CSI-RS).

13. The apparatus of claim 11, wherein the first sequence and the second sequence comprise an identical sequence structure.

14. The apparatus of claim 11, wherein the first sequence and the second sequence comprise a Zadoff-Chu (ZC)-based sequence.

15. The apparatus of claim 11, wherein the second sequence comprises a down sampled Zadoff-Chu (ZC)-based sequence compared to the first sequence.

16. The apparatus of claim 11, wherein a first comb number of the first reference signal is identical to a second comb number of the second reference signal.

17. The apparatus of claim 11, wherein a first density of the first reference signal is identical to a second density of the second reference signal.

18. The apparatus of claim 11, wherein a first density of the first reference signal is greater than a second density of the second reference signal.

19. The apparatus of claim 11, wherein the processor is further capable of:
differentiating the second reference signal according to an orthogonal cover code (OCC),
wherein the second reference signal further comprises the OCC.

20. The apparatus of claim 11, wherein the processor is further capable of:
determining the second reference signal according to a location of the time-frequency resource.
